(19) United States
(12) Patent Application Publication
(10) Pub. No.: US 2005/0080160 A1
(43) Pub. Date: Apr. 14, 2005

(54) Paints, coatings and polymers containing phytochemical agents and methods for making and using same

(76) Inventor: Samuel G. Seabrook JR., Mt. Pleasant, SC (US)

Correspondence Address: Judy Jarecki-Black, PH.D., J.D, 3239 Satellite Blvd., Duluth, GA, 30096, US

(21) Appl. No.: 10/917,698

(22) Filed: Aug. 12, 2004

Related U.S. Application Data
(60) Provisional application No. 60/495,044, filed on Aug. 14, 2003.
(60) Provisional application No. 60/496,996, filed on Aug. 21, 2003.

(51) Int. Cl. C09D 5/14; C08K 3/00

(52) U.S. Cl. 523/122; 106/15.05

(57) ABSTRACT

The present invention provides safe paint and coating compositions comprising at least one environmentally acceptable phytochemical such as, but not limited to capsicum, grapefruit seed extract and menthol suitable for use in preventing the colonization of a treated surface by a variety of biological species. One aspect of the invention is anti-fouling marine paints (coatings). Another aspect of the invention of the present invention provides paint and coating compositions comprising phytochemicals for use as an architectural paint. The compositions of the invention can further comprise control release agents such as, for example, antioxidants, oxidizers or photosensitive compounds to promote sustained release of the anti-colonization agents at the treated surface and to assist in the abrasion of the paint surface to mechanically dislodge the attaching organisms.

This application claims priority from U.S. provisional applications 60/495,044 filed Aug. 14, 2003 and 60/496,996 filed Aug. 21, 2003, both of which are incorporated herein by reference in their entireties

### FIELD OF THE INVENTION

This invention relates generally to coatings including marine and architectural paints containing one or more phytochemical agents for use in inhibiting the colonization of treated surfaces by animals and/or plants.

### BACKGROUND OF THE INVENTION

Historically, toxic chemicals, including the salts and oxides of heavy metals, have been added to marine paints to control fouling caused by the build up of plant and animal organisms on marine vessel hull bottoms and structures. This marine fouling can seriously diminish the performance of a ship's hull through the water, as well as causing structural damage. Both marine and freshwater vessels are susceptible to bottom fouling that can result in significant economic penalties.

Two chemicals, tributyltin (TBT) and cuprous oxide (copper), have been in commercial use for decades as toxic anti-fouling agents in marine paints. However, tributytin is now banned worldwide due to its high toxicity to free-floating marine organisms when leached into the surrounding water. Cuprous oxide is also of concern because of the build-up of high concentrations of copper ions in harbor sediment, again after leaching from the anti-fouling coatings. Both chemicals, therefore, have a detrimental impact on the marine environment worldwide and replacements are eagerly sought. However, attempts to replace the current toxic chemicals with alternatives that are non-toxic when released into the surrounding water, or mechanical alternatives that could dislodge attaching marine growths, have met with limited success.

Anti-fouling coatings typically comprise combinations of binders, pigments, additives and solvents. The binders determine the characteristics of the anti-fouling, including leaching of components. Pigments include the anti-fouling toxic agent(s) and various fillers. The solvents provide the application properties, while the additives are stabilizers for extended shelf life and to prolong the efficacy of the paint once applied to the ship surface.

The three classes of anti-fouling paints currently in use are leaching (hard and soft), ablative coatings and self-polishing coatings (polymers). Leaching (hard and soft) is the process whereby the toxicant comes out of the paint at a controlled and sustained rate. Ablative coatings comprise a soluble matrix in the coating (film) that is made up of the natural product rosin and hydrocarbons that act as a binder in the soluble matrix. Self-polishing anti-foulings are of two types, those containing tin (TBT) and those that are tin-free.

Besides the immersed hulls of ships and boats that are constantly exposed to an environment that allows the colonization and proliferation of attached marine plant and animal life, other non-marine structural surfaces often are subject to undesirable contamination. For example, in buildings high humidity and temperature can encourage mildew and other fungal or bacterial growth that frequently release airborne allergens thereby causing asthma and other ailments. Medical facility surfaces often demand a substantially reduced level of contaminating level of microbial colonization, usually achieved by disinfection, to avoid nosocomial infections. If persons or animals are to come into direct contact with architectural or other surfaces, it is desirable that active compounds incorporated in the protective coatings be both long lasting and present minimal environmental hazards, but are effective in reducing or eliminating the harmful microbial colonizations of the surface.

Phytochemicals are known which have broad activity, preventing or inhibiting the growth of a broad spectrum of microbes, as well as exhibiting efficacy against a range of potential marine fouling organisms such as, for example, barnacles, tubeworms and algae. For example, phytochemicals have been incorporated into polymeric films useful for wrapping and protecting foodstuffs during storage as described in U.S. Pat. No. 5,906,825. Capsicum, at high pungency levels, has been added to marine paints to prevent the fouling of ships bottoms, as described in U.S. Pat. No. 5,397,385. However, while showing efficacy against hard fouling by barnacles and mussels, there is limited effect in controlling soft fouling such as by algae. There is still an unmet need, therefore, treatments that can reduce or eliminate hard and soft fouling of submerged marine surfaces, as well as attachment and growth of drier surfaces by such as mildew, for example.

Phytochemicals that leach out of paint dilute and disperse extremely well into water and their biodegradability environmental acceptability. Their anti-fouling effect particularly resides in a surface effect that takes place only in the immediate environment of the painted or coated surface. This characteristic makes the compositions of the present invention comprising phytochemicals compatible with leaching coatings, ablative coatings and self-polishing coatings (polymers).

A need still exists, however, for safe, environmentally friendly alternatives to toxic additives in marine paints and architectural coatings that may be harmful to the applicant of the paint or to individuals who may come into direct contact with a treated surface.

### SUMMARY OF THE INVENTION

The present invention recognizes and addresses the foregoing disadvantages, and others of prior art constructions and methods. The present invention provides safe paint and coating compositions comprising at least one environmentally acceptable phytochemical suitable for use in preventing the colonization of a treated surface by a variety of biological species. One aspect, therefore, of the invention is anti-fouling marine paints (coatings). Another aspect of the invention of the present invention provides paint and coating compositions comprising phytochemicals for use as an architectural paint, including alkyl, polyvinyl acetate emulsion, polyvinyl chloride emulsion, water based epoxy resin, acrylic emulsion, acrylic resins, copolymers, synthetic composites, vinyls and other types of siding and derivatives thereof. The compositions of the invention can further comprise control release agents such as, for example, vitamin E or oxidizers or photosensitive compounds to promote sustained and release of the anti-colonization agents at the treated surface and to assist in the abrasion of the paint surface to mechanically dislodge the attaching organisms.

In various embodiments of the paints and coatings of the present invention, phytochemicals of the present invention may be added in any combination to leaching paints (hard and soft), ablative paints (coatings), self-polishing coatings (polymers), long life anti-fouling coatings and fouling-release coatings at levels of at least 0.01% to about 60% by v/v or weight to weight of the paint base.

In one embodiment of the present invention, the phytochemicals can be active in the inhibition or control of hard marine fouling (e.g. barnacles) and soft fouling (for example by algae) or a phytochemical may only be active against one type of fouling, and therefore a combination of phytochemicals is required to achieve efficacy.

In various embodiments of the invention, the phytochemical capsicum is combined with one or more other phytochemicals and added to a marine paint or coating to control marine fouling.

In other embodiments of the invention, the phytochemical capsicum is combined with one or more other phytochemicals and added to an architectural paint or coating to control biological colonization (fungal, algal or bacterial attachment) of an architectural painted surface.

In one embodiment, the phytochemical, capsicum may be combined with other phytochemicals and added to marine paint to control marine fouling, wherein the capsicum is substantially free of the heat causing ingredient capsaicin.

In one embodiment of the invention, the phytochemical grapefruit seed extract may be processed into a concentrated state and the glycol substantially removed from the extract before adding to marine paint or coating. In other embodiments, the phytochemical may be selected from extracts of cloves, eel grass, thyme, rosemary, sage, bayleaf, oregano, garlic, myrtle oil and/or clove oil.

In preferred embodiments of the invention, the paint comprises a paint base, grapefruit seed extract, a menthol or a preparation such as FRESCALIN™ that comprises a menthol derivative, and a capsicum preparation.

The phytochemical can be added to architectural and marine paints alone or in combination with other phytochemicals, or in combination with antioxidants such as Vitamin E or oxidizers or photosensitive compounds suitable for chemically disrupting the outer surface of the applied paint.

In an alternative embodiment, the phytochemical camphor is used in combination with other phytochemicals as a marine organism-fouling preventive. Camphor is a crystalline ketone derived from the wood of the camphor tree Cinnamomum camphora.

In another alternative embodiment, the paint phytochemical additive for fouling prevention may be lemon grass oil

In yet another alternative embodiment, the paint-fouling preventive may be Tea Tree oil. Tea Tree Oil is a natural by-product of the tea tree, (Melaleuca species).

In other embodiments of the compositions of the present invention, the phytochemical component may be selected from neem oil, tannic acid (tannins), menthol or derivatives thereof, camphor oil, clove and/or clove oil and garlic.

In one embodiment of the compositions of the present invention, the phytochemical combination comprises a capsicum preparation and tannic acid, and menthol or a derivative thereof. In another embodiment, the phytochemical combination comprises capsicum, tannic acid, clove oil, garlic and menthol. In yet another embodiment the phytochemical combination comprises a capsicum preparation, tannic acid, garlic and clove oil.

In one embodiment of the compositions of the present invention, the phytochemical combination comprises a capsicum preparation and tannic acid, and menthol or a derivative thereof. In another embodiment, the phytochemical combination comprises capsicum, tannic acid, clove oil, garlic, rosemary, sage, bayleaf, oregano and menthol. In yet another embodiment the phytochemical combination comprises a capsicum preparation, tannic acid, garlic and clove oil.

In one embodiment of the paints and coatings of the present invention, the phytochemical combination comprises capsicum and clove oil and optionally garlic. In another embodiment the phytochemical combination comprises capsicum, clove oil, garlic and Zostera noltil (eel grass),, with or without vitamin E. In one embodiment the phytochemical combination comprises capsicum, tannic acid, menthol and Zostera noltil (eel grass),. In still another embodiment the phytochemical combination comprises a capsicum preparation, menthol, grapefruit seed extract and Zostera noltil (eel grass),. In still another embodiment of the invention, the phytochemical combination comprises a capsicum preparation, menthol, grapefruit seed extract, neem oil and Zostera noltil (eel grass),. In yet another embodiment, the phytochemical combination comprises a capsicum preparation, menthol, and neem oil.

In embodiments of the paints and coatings of the present invention, phytochemicals of the present invention may be added in any combination to leaching paints (hard and soft), ablative paints (coatings), self-polishing coatings (polymers), longlife anti-fouling coatings and fouling-release coatings, at levels from about 0.01%to about 60% by volume or weight to weight.

In other embodiments of the paints and coatings of the present invention, phytochemicals of the present invention may be added in any combination to leaching paints (hard and soft), ablative paints (coatings), self-polishing coatings (polymers), longlife anti-fouling coatings and fouling-release coatings, at levels from about 0.01% to about 50% by volume or weight to weight.

### DETAILED DESCRIPTION OF THE INVENTION

The present invention provides paint and coating compositions comprising environmentally benign phytochemicals suitable for use in preventing the colonization of a treated surface by various biological species. One aspect, therefore, of the invention is anti-fouling marine paints (coatings). Another aspect of the invention of the present invention provides paint and coating compositions comprising phytochemicals for use as architectural paints, alkyl, polyvinyl acetate emulsion, polyvinyl chloride emulsion, water based epoxy resin, acrylic emulsion, acrylic resins, copolymers, synthetic composites, vinyls and other types of siding and derivatives thereof.

Definitions

The term “paint base” as used herein refers to a mixture of a polymeric primer, and a suitable solvent or suspension medium. It will be understood by one of skill in the art that the paint base is suitable for application to the submerged hull of a ship or boat, water intake and discharge systems for reservoirs and nuclear power plants (a marine paint base) and/or to the surface of, for example, a building or article of furniture (an architectural paint) and will provide a durable coating thereof. The paint may be an ablative paint wherein the immediate outer surface of the applied paint coating may be removed by frictional forces as a hull moves through water. The ablation will contribute to the mechanical removal of any colonizing organisms, as well as maintain the effective concentration of the phytochemical at the immediate surface. An ablative paint may include, for example, zinc oxide that provides a surface that may be sloughed off by the frictional action of water against the hull surface. It is contemplated, however, that the paint base for use in the compositions of the invention may comprise an oxidant that may disrupt the chemical structure of the exposed paint surface thereby allowing this surface to be removed by mechanical means such as wiping or by water jet or spray. Oxidative or photochemical breakdown of the paint surface is of particular use in architectural paints that are not subject to the continuous abrasive action of water over the treated surface. Suitable paint bases for use in the present invention include, but are not limited to an epoxy based paint, a silicone based paint, a polyurea resin, an alkyl, a polyvinyl acetate emulsion, a polyvinyl chloride emulsion, a water based epoxy resin, an acrylic emulsion, an acrylic resin, a copolymer, a synthetic composite, a vinyl, an ablative paint, a self-polishing paint, a leaching paint, a non-leaching paint, an oil-based paint, an aqueous-based paint and derivatives thereof.

The term “primer” as used herein refers to, but is not limited to, chlorinated natural rubber primer, epoxy resin primers, silicone elastomer primer, and epoxy polysiloxane.

The term “resin” as used herein refers to, but is not limited to, polysulfonates, silyl ether polymers, urea-based resins and polyphosphates.

The term “pigment” as used herein refers to, but is not limited to, calcium carbonate, zinc oxide, iron oxide).

The term “solvent” as used herein refers to, but is not limited to, xylene, methyl iso-butyl ketone, organic solvent including, but not limited to, acetone, turpentine and synthetic paint solvent. An acrylic based paint or medium may have as a solvent an aqueous based medium that may comprise other solvents including, for example, isopropanol.

The terms “binder” and “fouling control agent” as used herein refers to, but is not limited to, rosins, resins, acrylic siloxine, acrylic-siloxine graft copolymers, calcium carbonate, siloxanes, silicones, silylacrylates, hydrolysable; trimethylsilyloxyethyl methacrylate copolymer; thecopolymers, methyl acrylate, methyl methacrylate, styrene, lauryl methacrylate, vinyl acetate, vinyl chloride, acrylate copolymer paint binders and ester terminated silicones.

The term “anti-settling agent” as used herein refers to, but is not limited to, polyamide wax, paraffin waxes and hydrocarbon waxes.

The term “marine” as used herein refers to any aqueous environment including sea and freshwater either in the open environment such as the ocean, a lake or river, or any other extensively submerged surface such as the lining of a pipe or the inner surface of a fish tank, a water intake and discharge systems for reservoirs, for example.

The term “colonization” as used herein refers to the attachment of organisms to a surface. The attachment may result in the subsequent growth and proliferation of the organism on the surface.

The term “active concentration” as used herein refers to the concentration of the phytochemical agents available for exhibiting control of marine organism growth on surfaces below the water. For application in ablative paint (coatings), self-polishing coatings, longlife coatings and fouling release coatings the present invention, using phytochemicals alone or in combination, with or without migration control agents, active concentration levels of the phytochemical concentrations will repel or inhibit the growth of marine organisms on underwater surfaces that are safe for the environment.

The term ‘phytochemicals’ is herein defined to include complete, naturally occurring phytochemical molecular constructions, derivatives thereof, functional moieties thereof, and functionally identical manufactured molecular constructions as may be obtained based upon the naturally occurring compositions herein described. The term “phytochemical” as used herein refers to a compound or combination of compounds isolated from botanical sources and which may be incorporated in the present invention include, but are not limited to, Jasonia candicans (sesquiterpenes, lactones); Polygonum flaccidum (flavone and alpha santalene derivatives); Acalypha wikesiana (extracts); Pavetta owariensis (procyanidins); Plectranthus hereroensis (diterpenoids, diterpenes); Moss (Dicranin extract); Cannabis sativa (extract); Gloiosiphonia spp. (gloiosiphones); Laminaceae spp. (extract); Securidaca spp. (extract); Veronia spp. (extract); Hyptis umbrose (umbrosone); Asclepias syriaca (milkweed extract); Tagetes lenuifolia (thiophene); Calophyllum inophylloide (flavonoids); Tanacetum densum (sesquiterpene lactones, triterpenoids); Neorautanenia mitis (extract); Premna schimper (diterpene); Premna oligotricha (sesquiterpenes); Premna oligotricha (diterpenes); Jasonia candicans (essential oils); Visnea mocanera (beta-sitosterol, triterpenic betulinic acid, ursolic acid, plantanic acid); Asteraceae spp. (terthiophenes and polyynes); Petalostemum purpureum (extract); Camelia sinensis (catechin); Helichrysum picardii (flavonoids); Helichrysum italicum (flavonoids); Corydalis pallida (protoberberine alkloids); Shiraia bambusicola (perylenequinones); Fraxinum omus (hydroxycoumarins); Podocarpus nagi (totarol and nortiterpene dilactones); Heterotheca inuloides (sesquiterpenoids); Pelargonium spp. (essential oils); Piper sarmentosum (phenylpropanoids); Allium spp. (extract); Juniperus procera (diterpenes); Achillea conferta (flavonoids, flavones, sesquiterpenoid lactones); Magnolia virginiana (lignans, neolignans); Eucalyptus euglobal (euglobal); Armillaria mellea (armillaric acid); Dracena mannii (spirostanol saponin); Piper aduncum (chromenes, prenylated benzoic acid); Rhamnaceae spp. (cyclopeptide alkaloids); Buddleja globosa (verbascoside); Cephalocereus senilis (phytoalexin aurone); Salvia albocaerulea (diterpene); Gomphrena martiana and Gomphrena boliviana (extracts); Paepalanthus spp. (vioxanthin); Helichrysum stoechas and Helichrysum crispum (extracts); Achillea ptarmica (trans-pinocarveyl hydroperoxides); Dehaasia incrassata (alkaloids); Asteraceae spp. (extracts); Arctotis auriculate (extracts); Eriocephalus africanus (extracts): Felicia erigeroides (extracts); Hemerocallis fulva (phytosterols, fatty acid esters); Psoralea juncea (plicatin B); Pluchea symphytifolia (caffeic acid esters); Tovomitopsis psychotrifolia (Vitamin E derivative); Celosia argentea (triterpenoid saponins and flavonoids); Azadirachta indica (tetranortriterpenoid, mahmoodin, protolimonoids, naheedin); Moraceae spp. (coumarins); Hypericum erectum (phloroglucinol derivatives); Podospora appendiculate (Appenolides A, B, & C, furanones); Artemisia princeps var. orientalis, Artemisia capillaris, Artemisia mexicana and Artemisia scoparia (extract); Paddy malt (mash extract); Kigelia pinnata (extract); Acalypha wilkesiana (extract); seaweeds, seagrass and lemongrass (essential oils); Borrieria latifolia, Borreria setidens, Hedyotis diffusa), Hedyotis nudicaulis, Morinda elliptica, Morinda umbellata, Sida rhombifolia, and Vitex ovata (extracts); Tabebuia impetiginosa, Achyrocline spp., Larrea divaricata, Rosa borboniana, Punica granatum, Psidium guineense, Lithrea ternifolia (extracts); Lepechinia caulescens, Lepidium virginicum and Tanacetum parthenium (extracts); Talaromyces flavus (extracts); Daucus carota (extract); Flabellia petiolata, Caulerpa prolifera, Halimeda tuna, Corallina elongata, Lithophyllum lichenoides, Phyllophora crispa, Cystoseira spp., Halopteris spp., Codium spp., Valonia utricularis, Posidonia oceanica, Zostera noltii and Cymodocea nodosa (extracts); Centauraea orientalis, Diospyros khaki, Sida hermaphrodita, Forsythia intermedia, Scutellaria polydon, Eugenia malaccensis and Eugenia jambolana (extracts); Fritillaria L. spp. (ebeinone, steroidal alkaloids); Kigelia pinnata, Peperomia pellucida, Populus nigra, Populus balsamifera and Populus deltoides (extracts); Melaleuca alternifolia (essential oil); Elfvingia applanata (naringenin); Ficus sycomorus, grapefruit seed, Garlic, Allicin, Peat, Strophanthus hispidus, Secamone afzeli, Mitracarpus scaberi, Entada abyssinjca, Terminalia spinosa, Harrisonia abyssinica, Ximinea caffra, Azadirachta indica, Spilanthes mauritiana, Terminalia spinosa (extracts); Cyanobacteria (ambigols A and B, tjipanazole); coffee (extract); Sporochnus pedunculatus, Dalbergia melanozylon, Celastrus scandens, Juglans nigra, Kalmia latifolia, Pelargonium xhortorum, Rhus glabra and Lindera benzoin (extracts); Striga densiflora, Striga orobanchioides, Striga lutea, Pistacia lentiscus L., Mitracarpus villosus, Bixa orellana, Bridelia ferruginea, Alpinia katsumadai, Alpinia officinarum, Artemisia capillaris, Casia obtusifolia, Dendrobium moniliforme, Epimedium grandiflorum, Glycyrrhiza glabra, Lithosperum erythrorhizon, Magnolia obovata, Morus bonbycis, Natopterygii incisium, Polygonum multiflorum, Prunus mume, Rheum palmatum, Ricinus communis, Sophora flavescens, Swertia japonica, black pepper, rosemary, red pepper, Isopyrum thalictroides, Calotropis procera, Chrysanthemum spp., Holarrhena antidysenterica, Lunularia crusiata, Dumertiera hirsuta, Exormotheca tuberifera, and liverwort (extracts); Filipendula ulmaria, Salix glauca, Usnea filipendula, Clkadina arbuscula (salicylic compounds); Tanacetum parthenium, Thymus capitatus, and Elfingia applanata (extracts); Fraxinus ornus (hydroxycoumarins, esculin, esculetin, fraxin, and fraxetin); Zizyphus nummularia, LONGO VITAL, Pelargonium spp., Scaevola sericea, Psychotria hawaiiensis, Pipturus albidis, Aleurites moluccana, Solanum niger, Piper methysticum, Barringtonia asiatica, Adansonia digitata, Harungana madagascariensis, Jacaranda mimosaefolia, Erythroxylum catauba, Bidens pilosa, Lemna minor, Potamogeton spp., Nasturtium officinale, Apium nodiflorum, Agaricus subrutilescens, Amanita virosa, Amanita pantherina, Lycoperdon perlatum, Psidium guajava, Averrhoa carambola, musa sapientum, Carica papaya, Passiflora edulis, Lansium domesticum and Baccaurea motleyana (extracts); horse radish, celandine grass, bur marigold and yarrow grass (extracts); Abuta grandifola, Cyperus articulatus, Gnaphalium spicatum, Pothomorphe peltata, Ficus sycomorus, Ficus Benjamina, Ficus bengalensis, Ficus religiosa, Alchornea cordifolia, Bridelia feruginea, Eucalyptus citriodora, Hymenocardia acida, Maprounea africana, Monachora arbuscula, Tedania ignis, Arenosclera spp., Amphimedon viridis, Polymastia janeirensis, Aplysina fulva, Pseudaxinella lunaecharta, Nelumbium speciosum and Mycale arenosa (extracts); cloves (eugenol acetate and iso-eugenol); Chrysthanemum boreale (sesquiterpenoid lactones); Eucalyptus globolus, Punica granatum, Bocconia arborea, Syzygium brazzavillense, Syzygium guineense, Carthamus tinctorius), Ginkgo biloba, Mosla chinensis, Salvia officinalis, and Cinnamomum cassia (extracts); Cryptolepis sanguinolenta (alkaloids, cryptolepine); Chelidonium majus (alkaloids, berberine, coptisine); Vitex agnus-castus (extract); Cladonia substellata (usnic acid); Ellagic acid, Fuligo septica, Tubifera microsperma (extract); Mundulea monantha, Tephrosia linearis (flavonoids); Lpomoea fistulosa (extract); Pimenta dioica (essential oils); Ratibida lalipalearis, Teloxys graveolens, Dodonaea viscosa, Hypericum calycinum, Hyptis albida, Hyptis pectinata, Hyptis suaveolens and Hyptis verticillata (extracts); Asteriscus graveolones (bisabolone hydroperoxides); Derris scandens, Alnus rubra, Araliaceae family (extracts); Vinca rosea, Australian tea tree oil, peppermint oil, sage oil, thymol, eugenol and Thuja orientalis (extracts); Anacardium occidentale (phenolic lipids); Oidiodendron tenuissimum (extract); Acacia nilotica and Acacia farnesiana (polyphenol, tannin); Teminalia alata and Mallotus phillipinensis (extracts); Piectranthus grandidentatus (abientane diterpenoids); Pumica granatum and Datura metel (extracts); tea, Agave lecheguilla, Chamaesyce hirta, Baccharis glutinosa and Larrea tridentata (extracts); Camelia sinensis and Euphorbia hirta (theaflavin, polyphenon 60); Tabernaemontana pandacaqui, Yucca shidigera, Hemistepa lyrata, Yougia japonica, Prunella vulgaris, Lamium amplexicaule, Juniperus chinensis, Ixeris dentata, Gnaphalium affine, Chelidonium majus, Spirea prunifolia, Erythronium japonicum, Taxus wallichiana, Ganoderma lucidum Drava nemorosa, Youngia capillaris, Equisetum arvense, Australiam Lavender, Black Seed, Catuaba casca, Cineole, Damiana, Dicranum scoparium, Eucalptus oil, Ginger, and Grape seed (extracts); Neem seed, bark, and leaf extract; Neem oil; New Zealand Manuka extract; Nicotiana tabacum extract; olive leaf extract; a-pinene and b-pinene extracts; Rhubarb root extract; Syringa vulgaris extract; Tea tree oil (Terpinen-4-ol, a-terpinene, y-terpinene, a-terpineol, Terpinolene); Thyme (extract) and Vitamin E (extract).

Organisms Inhibited by Phytochemicals

Organisms which may be inhibited by phytochemicals useful in the present invention include, but are not limited to:

Fungi Aspergillus flavus, A. fumigalus, A. niger, Blastomyces dermatitidis, Candidaspp., Coccidioides immitis, Cryptococcus neoformans, Fusarium culmorum, Geotrichum spp., Histoplasma capsulatum, Malassezia furfur, Microsporum spp., Mucor racemosus, Nocardia spp., Paracoccidioides brasiliensis, Penicillium spp., Rhizopus higricans, Saccharomyces cerevisiae, Sporothrix schneckii, Torulopsis spp., Trichophyton spp.

Bacteria Aerobacter aerongenes, Aeromonas hydrophila, Bacillus cereus, Bacillus subtilis, Bordetella pertussis, Borrelia burgdorferi, Campylobacter fetus, C. jejuni, Corynebacterium diphtheriae, C. bovis, Desulfovibrio desulfurica, Escherichia coli 0157:H7, Enteropathogenic E. coli, Enterotoxin-producing E. coli, Helicobacter pylori, Klebsiella pneumoniae, Legionella pneumophila, Leptospira interrogans, Mycobacterium tuberculosis, M. bovis, Neisseria gonorrhoeae, N. meningitidis, Proteus mirabilis, P. vulgaris, Pseudomonas aeruginosa, Rhodococcus equi, Salmonella choleraesuis, S. enteridis, S. typhimurlum, S. typhosa, Shigella sonnei, S. dysenteriae, Staphylococcus aureus, S. epidermidis, Streptococcus anginosus, S. mutans, Vibrio cholerae, Yersinia pestis, Y. pseudotuberculosis, Actinomycetes, Stretomyces reubrireticuli, Streptoverticillium reticulum, Thermoactinomyces vulgaris

Viruses

Adenoviruses, Coronaviruses, Cytomegalovirus, Enteroviruses, Epstein-Barr virus, Herpes simplex virus, Hepatitis viruses, Human Immunodeficiency virus, Human Parvoviruses, Influenza viruses, Morbillivirus, Mumps virus, Norwalk viruses, Papillomaviruses, Paromyxovirus, Poxvirus, Rabies virus, Reoviruses, Rotaviruses, Rubella virus, Respiratory Synctial virus, Rhinoviruses, Varicella zoster virus

Parasites

Ancyclostoma braziliense, Anisakis, Babesia microti, Balantidum coli, Blastocystis hominis, Chilomastix mesnili, Cryptosporidium parvum, Cyclospora, Dientamoeba fragilis, Diphyllobothrium latum, Echinococcus granulosus, Entamoeba coli, E. histolytica, Enterocytozoon, Fasciola hepatica, Giardia lamblia, Iodamoeba butschlii, Isospora belli, Leishmania brasiliensis, L. donovani, L. tropica, Paragonimus westermani, Plasmodium vivax, Pnemocystis carinii, Sarcocytis hominis, Strongyloides stercoralis, Taenia solium, Toxoplasma gondii, Trichomonas vaginalis, Trichinella spiralis, Trypanosoma cruzi.

It is further intended that the compositions of the present invention will be effective against marine and/or freshwater organisms capable of attaching to and colonizing the submerged hull surfaces of ships and boats, water intakes and discharge systems for reservoirs and nuclear power plants, including parazoans, coelenterates such as polychaete and oligochaete worms, mollusks including zebra mussels, arthropods including crustaceans such as, but not limited to, acorn and goose barnacles and to be effective in inhibiting the attachment and or development of the adult or larval forms of the targeted organisms. The compositions of the present invention can also be effective against marine and freshwater plants including algae and higher plants that can attach to a ship hull and other underwater surfaces.

Exemplary phytochemicals which exhibit activity against multiple organisms are illustrated in Table 1 below. Each phytochemical is classified as to general activity (anti-bacterial; anti-viral; anti-fungal; anti-crustacean; larvicidal; insecticidal; molluscicidal; or anti-nematodal) and examples of organisms against which the phytochemical is active are provided. It should to be recognized that the phytochemicals included in the table are for illustrative purposes only and are not meant to an exhaustive listing and with the recognition that certain phytochemicals may be active against more than one class of organism:

TABLE 1

| | |
|---|---|
| Phytochemical | Known Target Organism |

Anti-bacterial

| | |
|---|---|
| Annona muricata {Annonaceae) | B. subtilis; E. coli |
| A. squamosa | B. subtilis |
| Panax ginseng {Araliaceae) | E. coli; P. aeruginosa; S. enteritidis |
| Capparis spinosa {Capparidaceae) | E. coli |
| Calendula officinalis {Compositae) | B. subtilis; S. lutea; S. aureus |
| Cynara scolymus {Compositae) | E. coli |
| Cucurbita pepo {Cucurbitaceae) | S. aureus*** |
| Cymbopogon citratus {Gramineae) | B. subtilis; B. mycoides; S. aureus; E. coli |
| Mentha spicata {Labiatae) | E. coli |
| Ocimum basilicum {Labiatae) | B. anthracis; B. cereus; S. aureus; B. subtilis; P. aeruginosa; |
| Rosmarinus officinalis {Labiatae) | S. pneumoniae; Actinomycetes |
| Glycyrrhiza glabra {Leguminosae) | B. subtilis; B. cereus; P. aeruginosa; S. typhi; |
| | S. aureus |
| Allium sativum (Liliaceae) | B. subtilis; S. aureus; S. mutans |
| Aloe vera {Liliaceae) | B. subtilis;*** H-17(rec+); C. perfringens; E. amylovora; E. coli; |
| Citrus reticulata {Rutaceae) | K. pneumoniae; X. campestris; P. aeruginosa; S. enteritidis; |
| Oenothera biennis {Onagraceae) | S. aureus; S. sanguis; E. carotovora |
| Plantago major {Plantaginaceae) | B. subtilis; C. xerosis; P. vulgaris |
| Punica granatum {Punicaceae) | E. coli; P. vulgaris; P. aeruginosa; S. mutans |
| Ribes nigrum {Saxifragaceae) | S. mutans |
| Camellia sinensis {Theaceae) | S. dysenteriae |
| Curcuma longa {Zingiberaceae) | B. anthracis; B. subtilis; E. coli;*** K. pneumoniae; P. aeruginosa; |
| Zingiber officinale {Zingiberaceae) | S. aureus |
| | E. coli |
| | Actinomycete sp.; B. pertussis; E. coli; P. shigelloides; P. aeruginosa; |
| | S. aureus; V. cholera |
| | B. subtilis; L. acidophilus; H-17(rec+) |
| | B. subtilis; B. anthracis; E. coli; L. acidophilus; S. aureus |

Anti-fungal

| | |
|---|---|
| Annona muricata {Annonaceae) | Penicillium oxalicum |
| Panax ginseng {Araliaceae) | Rhizopus nigricans; Saccharomyces uvarum |
| Capparis spinosa (Capparidaceae) | Candida pseudotropicalis |
| Calendula officinalis (Compositae) | Neurospora crassa; Candida albicans; C. monosa |
| Cucurbita pepo (Cucurbitaceae) | Neurospora crassa |
| Cymbopogon citratus (Granimeae) | Absidia spinosa; Alternaria solani; Aspergillus niger; |
| | Curvularia lunata; Epidermophyton floccosum; |
| | Microsporum audouini; Trichophyton mentagrophytes; |
| Mentha spicata (Labiatae) | Candida albicans; Cryptococcus neoformans; |
| Ocimum basilicum (Labiatae) | Saccharomyces cerevisiae |
| Rosmarinus officinalis (Labiatae) | A. niger; F. oxysporum; F. sp. Lentis;*** Trichophyton |
| | rubrum |
| Glycyrrhiza glabra | Absidia ramosa;*** Alternaria longipes; Aspergillus |
| (Leguminoseae) | aegyptiacus; A. awamori; MIcrosporum gypseum; |
| Allium sativum (Liliaceae) | Trichoconiella padwickii; C. albicans; Kloeckera |
| | apiculata |
| | F. oxysporum; M. icrosporum canis; P. cyclopium; C. albicans; |
| | Rhodotorula rubra; T. rubrum |
| Aloe vera (Liliaceae) | Aspergillus auricomus; T. mentagrophytes; C. albicans |
| Sesamum indicum {Pedaliaceae) | A. aegyptiacus;***A. fumigatus; A. niger; Botryotrichum |
| Punica granatum {Punicaceae) | keratinophilum; E. floccosum; F. moniliforme; F. oxysporum; |
| Citrus aurantium {Rutaceae) | Geotrichum candidum; M. canis; Nannizzia |
| Citrus reticulata {Rutaceae) | fulva; Penicillium digitatum; T. rubrum; T. semii; C. albicans; |
| Ribes nigrum {Saxifragaceae) | C. krusei; C. pseudotropicalis; C. neoformans; |
| Camellia sinensis {Theaceae) | Debaryomyces hansenii; Kloeckera apiculata; Rhizopus |
| Curcuma longa {Zingiberaceae) | rhizopodiformis; T. padwickii |
| Zingiber officinale {Zingiberaceae) | T. Mentagrophytes |
| | Cladosporium cucumerinum |
| | A. niger; C. albicans*** |
| | A. aegyptiacus;*** T. rubrum; C. albicans; C. lipolytica |
| | A. niger; P. cyclopium; C. albicans |
| | P. digitatum |
| | E. floccosum; T. mentagrophytes; S. cerevisiae; |
| | Alternaria tenuis |
| | Debaryomyces hansenii; A. flavus; A. niger; E. floccosum; |
| | Trichoderma viride |
| | A. niger; A. auricomus; A. flavus; Botrytis cinerea; N. crassa; |
| | T. padwickii; C. albicans; S. pastorianus |

Anti-viral

| | |
|---|---|
| Annona squamosa (Annonaceae) | HIV-1 |
| Panax ginseng {Araliaceae) | Adenovirus 3; herpes simplex 1 virus; semlicki-forest |
| Capparis spinosa (Capparidaceae) | virus; rauscher murine leukemia virus |
| Calendula officinalis (Compositae) | Hepatitis virus |
| Mentha spicata (Labiatae) | Encephalitis virus-unspec.; herpes simplex virus; HIV-1 |
| Rosmarinus officinalis (Labiatae) | Herpes virus type 2 |
| Glycyrrhiza glabra (Leguminoseae | Herpes virus type 2 |
| Allium sativum {Liliaceae) | Rauscher murine leukemia virus |
| Aloe vera {Liliaceae) | Cytomegalovirus; herpes simplex 1 virus; herpes simplex |
| Punica granatum {Punicaceae) | 2 virus |
| Ribes nigrum {Saxifragaceae) | Cytomegalovirus; herpes simplex 1 virus |
| Camellia sinensis {Theaceae) | Coxsackie B5 virus; hepatitis B virus; herpes simplex 1 |
| Curcuma longa {Zingiberaceae) | virus;*** herpes simplex 2 virus |
| Zingiber officinale {Zingiberaceae) | Encephalitis virus (tick-borne) |
| | Coxsackie A9 virus; influenza virus A; influenza virus A2 |
| | (manheim 57); poliovirus I |
| | Hepatitis B virus; vesicular stomatitis virus |
| | Herpes simplex 1 virus; rhinovirus type 1-B; virus-lpp1; |
| | rauscher murine leukemia virus |
| Anti-crustacean | |
| Annona muricata (Annonaceae) | Artemia salina larvae; Artemia salina*** |
| Zingiber officinale {Zingiberaceae) | Aremia salina |

Insecticide

| | |
|---|---|
| Annona muricata (Annonaceae) | Macrosiphoniella sanborni*** |
| Annona reticulata {Annonaceae) | Macrosiphoniella sanborni;***Oryzaephilus |
| Annona squamosa (Annonaceae) | surinamensis; Tribolium castaneum |
| Cucurbita pepo (Cucurbitaceae) | Callosobruchus chinensis; Drosophila melanogaster; |
| | M. Sanborni;***Musca Domestica; Pediculus Capitis |
| Mammea americana {Guttiferae) | Culex quinquefasciatus |
| Mentha spicata (Labiatae) | Aedes aegypti;***Serotoma ruficornis, adults*** |
| Ocimum basilicum (Labiateae) | Drosophila auraria; Mites (Pyroglyphidae) |
| Rosmarinus officinalis (Labiatae) | Culex quinquefasciatus |
| Citrus reticulata {Rutaceae) | Drosophila auraria |
| Curcuma longa {Zingiberaceae) | Sitophilus granarius |
| | Macrosiphum euphorbiae |

Larvicidal

| | |
|---|---|
| Annona squamosa | Anopheles stephensi larvae |
| Mammea americana {Guttiferae) | Diaphania hyalinata; Laphygma frugiperda*** |
| Ocimum Basilicum (Labiateae) | Culex fatigans;*** Diacrisia obliqua |
| Allium sativum {Liliaceae) | Culex pipiens-quinquefasciatus (1st instar larvae) |
| Curcuma longa {Zingiberaceae) | Spodoptera litura Larvae |

Molluscicidal

| | |
|---|---|
| Annona squamosa (Annonaceae) | Biomphalaria straminea |
| Ocimum Basilicum (Labiateae) | Biomphalaria pfeifferi |
| Camellia sinensis {Theaceae) | Biomphalaria glabrata |

Antinematodal

| | |
|---|---|
| Glycyrrhiza glabra (Leguminoseae | Meloidogyne Incognita*** |
| Phaseolus vulgaris {Leguminosae) | Heterodera glycines |

***strong activity for phytochemical

One aspect of the present invention, therefore, provides paint and coating compositions, especially a marine paint for the anti-fouling treatment of the submerged portion of the hull of a ship or boat, water intake and discharge systems for reservoirs and nuclear power plants, comprising an environmentally friendly anti-fouling additive in the form of at least one phytochemical and menthol. In general terms, the present invention is directed to paints, coatings and polymers containing phytochemicals and methods of making and using the same. Phytochemicals especially useful in the present invention include, but are not limited to, grapefruit seed extract, capsicum preparations, tannins, tannic acid, neem oil, menthol, camphor, camphor oil, zosteric acid, Zostera noltil (eel grass),, eel grass extract, lemon grass oil, myrtle oil, thyme extract, rosemary, sage, bayleaf, oregano, tea tree oil, clove oil, garlic, citric acid, vitamin E, and other phytochemicals exhibiting activity to be used in any combination or derivatives thereof wherein the derivative may be active alone or in combination with a natural phytochemical or biocide to inhibit the colonization of a treated surface. Grapefruit seed extract is an effective phytochemical biocide with activity against bacteria, fungi, algae and some parasites and is available commercially as CITRICIDAL from Bio/Chem Research (Lakeport, Calif.). Capsicum preparations that may be used in the invention may be, but not necessarily so, substantially free of capsaicin, the pungency component of the ‘hot pepper extracts’. Capsicum is available commercially from, for example Kalsec, Inc., Kalamazoo, Mich. Menthol, tea tree oil, clove oil, citric acid, garlic extract, thyme extract are commercially available from Aldrich Chemical, Los Angeles, Calif. Menthol derivatives, such as FRESCALIN™, suitable for use in the present invention are commercially available from Symrise, GmbH & Co., Holzminden, Germany.

The rate of migration or the release of the phytochemical composition contained within the marine and architectural paints, coatings and polymers may be modified by further including in the compositions a release agent such as Vitamin E, a chemical releaser such as citric acid, or an anti-oxidant such as Vitamin E. The chemical releaser may be the same as the phytochemical agent. Vitamin E further possesses antimicrobial properties, and thus may function as a phytochemical, which may work in conjunction with or separately from marine paint binders.

Phytochemicals suitable for use in the compositions of the present invention and which are known to function as anti-oxidants, as well as to possess antimicrobial properties include, but are not limited to, Panax ginseng; Panax quinquefolius; Bixa orellana; Humulus lupulus; Spinacia oleracea; Arctium lappa; Cichorium intybus; Cynara scolymus; Helianthus annuus, Inula helenium; Armoracia rusticana; Momordica charantia; Vaccinium corymbosum; Vaccinium myrtillus; Avena sativa; Oryza sativa; Lavandula latifolia; Marrubium vulgare; Melissa officinalis; Mentha pulegium; Mentha spicata; Nepeta cataria; Ocimum basilicum, Origanum onites; Perilla frutescens; Prunella vulgaris, Rosmarinus officinalis; Salvia officinalis; Salvia sclarea; Satureja hortensis; Thymus vulgaris; Laurus nobilis; Arachis hypogaea; Glycine max; Glycyrrhiza glabra; Glycyrrhiza uralensis; Lens culinaris; Phaseolus coccineus; Phaseolus lunatus; Phaseolis vulgaris; Phaseolus vulgaris; Pisum sativum; Psophocarpus tetragonolobus, Pueraria lobata; Tamarindus indica; Tamarindus indica;* Vicia faba, Vigna angularis; Vigna mungo; Vigna radiata; Allium ampeloprasum; Allium cepa; Allium sativum; Asparagus officinalis, Linum usitatissimum; Morus alba; Eucalyptus globulus; Pimenta dioica; Syzygium aromaticum; Olea europaea; Oenothera biennis; Sesamum indicum; Plantago asiatica; Fagopyrum esculentum; Prunus cerasus; Prunus spinosa; Rosa canina; Rubus fruticosus; Rubus idaeus; Coffea arabica; Citrus aurantium; Citrus paradisi, Ribes nigrum; Ribes rubrum; Capsicum frutescens, Solanum tuberosum; Solanum tuberosum; * Theobroma cacao; Camellia sinensis; Coriandrum sativum; Cuminum cyminum; Daucus carota, Trachyspermum ammi; Vitis vinifera; Curcuma longa; Zingiber officinale. Other antioxidants that are useful in the present invention include, but are not limited to, lysine, butylatedhydroxytoulene (BHT), butylatedhydroxyanisole (BHA), grape seed extract, Pine Bark extract (Proanthocyanidins), β-carotene, bilberry extract, ascorbic acid, Ginkgo biloba extract, green tea extract, tumeric, zinc picolinate, zinc oxide, iron oxide, calcium carbonate and selenium. Selected antioxidant(s) may be used alone or in combination when combined with the phytochemical(s) in the coating formulas of the present invention.

For applications using leaching paints (coatings), ablative paints (coatings) or self-polishing coatings (polymers) wherein the phytochemical component of the paint compositions comprises a capsicum preparation, grapefruit seed extract, menthol, thyme, clove oil, rosemary, sage, bayleaf, oregano, lemon grass oil tannin, tannic acid, camphor, camphor oil or Zostera noltil, (eel grass extract or derivatives thereof) for their organism inhibiting activity, with or without a migration release agent, the components of the leaching paints (coatings), ablative paints (coatings) and self-polishing polymers (coatings) may contain any combination of the primers, resins, pigments, solvents, paint binders and anti-settling agents known to those of skill in the art that provide effective application properties to, for example, the submerged region of a ship's hull

It should be understood that the present invention is broadly drafted, in one embodiment, towards incorporating a phytochemical or combination of phytochemicals into polymeric materials as agents to inhibit the colonization of a painted surface by animal and/or plant organisms. In several preferred embodiments of the present invention, capsicum, menthol and grapefruit seed extract may be used as agents. The present invention, however, encompasses the use of many other agents. In the various embodiments of the invention, a preferred phytochemical is a capsicum preparation, alone or in combination with other phytochemicals for use as a fouling preventive agent in marine paints (coatings). Capsicum is a food or food seasoning commonly known as “hot pepper.” The active heat ingredient in capsicum is capsaicin which is a mixture of two unsaturated and three saturated homologs. This mixture is also referred to as capsaicinoids, and includes dihydrocapsaicin and nordihydrocapsaicin. The pungency of capsaicin (capsiacinoids) is measured in Scoville heat units and typically ranges from 60,000 to 1,500,000 heat units. The compositions of the present invention, however, may comprise capsicum preparations having Scoville heat units from about 0 to at least 1.5 million. While capsaicin itself does not have antimicrobial qualities, other chemical ingredients in capsicum do have antimicrobial activity, such as; 1,8-cineole, acetic acid, alpha-terpineol, benzaldehyde, beta-ionone, caffeic acid, caryophyllene, chlorogenenic acid, cinnamic acid, delta-3-carene, ferulic-acid, limonene, myrcene, p-coumaric-acid, pulegone, querectin, rutin, scopoletin, terpinen-4-ol and thujone. It is contemplated, therefore, that a capsicum preparation with the removal of the active heat ingredients, either partially or totally, for use as an anti-fouling additive in marine and especially in architectural paints (coatings), is possible, even though the heat unit index, before processing of the capsicum may have been at any value, it would no longer have a pungency factor in the finished product.

Also useful in the present invention as a fouling preventive additive in marine paints (coatings) is the phytochemical tannic acid. Tannins are classified into two broad groups: the hydrolysable and the condensed or non-hydrolysable tannins. The hydrolysable tannins are usually compounds containing a central core of glucose or other polyhydric alcohol esterified with gallic acid (gallotannins) or hexahydroxydiphenic acid (ellagitannins). The condensed ones are mostly flavolans or polymers of flavan-3-ols (catechins) and/or flavan 3:4-idols (leucoanthocyanidins). They are more resistant to breakdown. Frequently, tannins isolated from a plant bear the characteristics of both groups. Tannins may occur in almost any part of a plant-root, stem, trunk bark, leaves and fruit.

Neem (Azadirachta indica) repels and disrupts the growth and reproduction of many destructive insect species. Unlike many synthetic insecticides, low doses of azadirachtin, an active anti-insect component of neem and extracts thereof, have little or no mammalian toxicity. Little resistance has been shown by insects over several generations. Insects affected by neem includes termites, beetles, flies, caterpillars, true bugs, locusts and grasshoppers, aphids, weevils, moths, and roaches. Components of neem extracts comprise about 50% oleic acid, about 20% stearic acid, about 12.6% palmitic acid, about 2% linoleic acid and about 2% of a variety lower fatty acids.

The compositions of the invention may further comprise menthol or a derivative thereof such as, but not limited to, mentholpropylreneglycolcarbonate. A particularly useful synthetic menthol preparation for inclusion in the compositions of the present invention is FRESCALIN™ (Symrise GmbH & Co, Holzminden, Germany) and comprising at least 50% by weight of isopulegol, between 0.01% and 49.99% by weight of 5-methyl-2-(1-methylethyl)-cyclohexanol and between 0.01% and 50% by weight of mentholpropylreneglycolcarbonate. This synthetic menthol preparation is especially effective with any combination of capsicum, grapefruit seed extract or natural menthol at inhibiting marine growth when included in anti-fouling paints and coatings.

The compositions of the present invention may further include a chemical releaser, which is used to facilitate the controlled release of the phytochemical from the polymer or paint matrix. The chemical releaser facilitates the release of the phytochemical composition from the polymer or paint. The releaser may be, for example, citric acid, a phytochemical that also exhibits antibacterial activity. Zinc oxide, iron oxide or citric acid extract can be added to the polymer or paint (coatings) alone or in combination with other phytochemicals, with or without anti-oxidants like Vitamin E. The release agents used in the phytochemicals and the release agents used in the marine paints, coatings and polymers can have a synergistic effect, depending on the desired release, erosion or ablative rate of the marine paints, coatings and polymers containing phytochemicals to prevent marine organism fouling.

While not wishing to be bound by any one theory, the addition of the phytochemicals to the paint base increase the efficacy of the applied paint to remove newly attached organisms by slowing or inhibiting the attachment and growth of the animals and plants. This delay in their forming a firm attachment such as, for example, through the development of a secure holdfast by algae allows the ablative loss of the outer surface of the paint layer to more effectively dislodge the organisms. In the case of architectural paints applied to a non-submerged surface, the reduction in the colony load can allow more effective removal of the outer paint layer and any cells clinging thereto. It is also contemplate, however, that the phytochemicals can be effective in repelling non-attaching organisms such as termites that may otherwise penetrate or contact a painted layer.

The amounts (by volume or by weight) and combinations (number) of the phytochemical agents added to the paints (coatings) therefore may be adjusted according to the particular application, relevant factors including the conditions under which the phytochemical composition is to be used, the type of paint, coating or polymer (leaching, ablative, self-polishing), the thickness of the paint, coating or polymer, the rate of release of the phytochemical and the leach, ablation or polishing rate, the types of marine organisms that need controlling may vary, the duration of the use of the phytochemicals in these coatings, and the active concentration of the phytochemical desired. In some cases there may be a need for additional substances such as wetting or emulsifying agents, pH buffering agents, adjuvants, gelling or viscosity enhancing additives, preservatives, colors, and the like, depending upon the use. The present invention also provides paint compositions, and their methods of use, formulated for application in non-marine environments such as architectural paints. In such cases, the rate of leaching of the agents will not be as great as if the paint is immersed in marine or freshwater, and the effective amount of the phytochemicals can be adjusted accordingly. In the case of architectural paint formulas that incorporate phytochemicals, oxidizers may be used to cause oxidation and loss of the paint surface in a manner similar to that of zinc oxide which enhances the ablation of the paint surface in an aqueous environment.

When making any of the compositions of the present invention, the phytochemicals, menthol and other desired components may be added either together or sequentially to a paint base selected for the particular application. The mixture is then mixed until the phytochemicals are evenly dispersed within the paint, coating or polymer. The applications of the finished product may be brushed or sprayed on a surface to be coated.

In various embodiments of the paints and coatings of the present invention, phytochemicals of the present invention may be added in any combination to leaching paints (hard and soft), ablative paints (coatings), self-polishing coatings (polymers), long life anti-fouling coatings and fouling-release coatings at levels of at least 0.01% to about 60% by v/v or weight to weight of the paint base.

In one embodiment of the present invention, the phytochemicals can be active in the inhibition or control of hard marine fouling (e.g. barnacles) and soft fouling (for example by algae) or a phytochemical may only be active against one type of fouling, and therefore a combination of phytochemicals is required to achieve efficacy.

In various embodiments of the invention, the phytochemical capsicum is combined with one or more other phytochemicals and added to a marine paint or coating to control marine fouling.

In other embodiments of the invention, the phytochemical capsicum is combined with one or more other phytochemicals and added to an architectural paint or coating to control biological colonization (fungal, algal or bacterial attachment) of an architectural painted surface.

In one embodiment, the phytochemical, capsicum may be combined with other phytochemicals and added to marine paint to control marine fouling, wherein the capsicum is substantially free of the heat causing ingredient capsaicin.

The phytochemical grapefruit seed extract may be added to paint (coatings) to control marine fouling. In one embodiment of the invention, the phytochemical grapefruit seed extract may be processed into a concentrated state and the glycol substantially removed from the extract before adding to marine paint or coating. In another embodiment, the phytochemical may be selected from extracts of cloves, rosemary, sage, bayleaf, oregano, eel grass, thyme, garlic and/or clove oil.

In preferred embodiments of the invention, the paint comprises a paint base, grapefruit seed extract, a menthol or a preparation such as FRESCALIN™ that comprises a menthol derivative, and a capsicum preparation.

The phytochemical grapefruit seed extract exhibits anti-bacterial, anti-parasitic and anti-fungal activity. Grapefruit seed extract is available commercially such as CITRICIDAL™. The grapefruit seed extract can be added to architectural and marine paints alone or in combination with other phytochemicals, or in combination with antioxidants such as Vitamin E or oxidizers or photosensitive compounds suitable for chemicaly disrupting the outer surafce of the applied paint.

In an alternative embodiment, the phytochemical camphor is used in combination with other phytochemicals as a marine organism-fouling preventive. Camphor is a crystalline ketone derived from the wood of the camphor tree Cinnamomum camphora.

In another alternative embodiment, the paint phytochemical additive for fouling prevention may be lemon grass oil which is a natural by-product of lemon grass and is extracted by steam and other nontoxic extraction methods. Lemon grass oil exhibits anti-fungal and anti-bacterial activity and may be added to marine paints in combination with other phytochemicals. Antioxidants, such as Vitamin E, or releasers, such as citric acid may also be added with the phytochemical composition to the marine paints.

In yet another alternative embodiment, the paint-fouling preventive may be Tea Tree oil. Tea Tree Oil is a natural by-product of the tea tree, (Melaleuca species). Tea Tree Oil is extracted through natural non-toxic processes such as steam. Tea Tree Oil exhibits anti-fungal and anti-bacterial activity. Tea Tree Oil may be added to marine paints in combination with other phytochemicals, oxidizing releasers, or antioxidants like Vitamin E.

In other embodiments of the compositions of the present invention, the phytochemical component may be selected from neem oil, tannic acid (tannins), menthol or derivatives thereof, camphor oil, clove and/or clove oil and garlic.

In one embodiment of the compositions of the present invention, the phytochemical combination comprises a capsicum preparation and tannic acid, and menthol or a derivative thereof. In another embodiment, the phytochemical combination comprises capsicum, tannic acid, clove oil, garlic and menthol. In yet another embodiment the phytochemical combination comprises a capsicum preparation, tannic acid, garlic and clove oil.

In one embodiment of the paints and coatings of the present invention, the phytochemical combination comprises capsicum and clove oil and optionally garlic. In another embodiment the phytochemical combination comprises capsicum, clove oil, garlic and Zostera noltil (eel grass), with or without vitamin E. In one embodiment the phytochemical combination comprises capsicum, tannic acid, menthol and Zostera noltil (eel grass). In still another embodiment the phytochemical combination comprises a capsicum preparation, menthol, grapefruit seed extract and Zostera noltil (eel grass). In still another embodiment of the invention, the phytochemical combination comprises a capsicum preparation, menthol, grapefruit seed extract, neem oil and Zostera noltil (eel grass). In yet another embodiment, the phytochemical combination comprises a capsicum preparation, menthol, and neem oil.

In embodiments of the paints and coatings of the present invention, phytochemicals of the present invention may be added in any combination to leaching paints (hard and soft), ablative paints (coatings), self-polishing coatings (polymers), longlife anti-fouling coatings and fouling-release coatings, at levels from about 0.01% to about 60% by volume or weight to weight.

In other embodiments of the paints and coatings of the present invention, phytochemicals of the present invention may be added in any combination to leaching paints (hard and soft), ablative paints (coatings), self-polishing coatings (polymers), longlife anti-fouling coatings and fouling-release coatings, at levels from about 0.01% to about 50% by volume or weight to weight.

A concentrate (liquid or powder) comprising about 4% capsicum may be used in the paint compositions of the invention at a concentration of between about 0.01% and about 60% v/v or weight to weight of a liquid paint base. In one embodiment of the compositions of the invention, the 4% capsicum concentrate (liquid or powder) may be between about 0.01% to about 15% v/v or weight to weight of a liquid paint base. In another embodiment, a concentrate (liquid or powder) comprising about 14% capsicum may be used at a concentration of between about 0.01% to about 60% v/v or weight to weight of a liquid paint base, preferably between about 0.01% to about 15% v/v or weight to weight of a liquid paint base. In yet another embodiment, a concentrate (liquid or powder) comprising about 87% capsicum may be used at a concentration of between about 0.01% to about 60% v/v or weight to weight of a liquid paint base, preferably between about 0.01% to about 15% v/v or weight to weight of a liquid paint base. In the various embodiments of the invention, menthol (liquid, crystals or powder) may be included at a concentration of between about 0.01% and about 60% v/v or weight to weight of a liquid paint base. In other embodiments, the concentration of the menthol may be between about 0.01% to about 15% v/v or weight to weight of the liquid paint base.

In another embodiment of the invention, the compositions may further comprise a mixture, said mixture comprising grapefruit seed extract and menthol (liquid, crystals or powder) in a weight-to-weight ratio range of from about 0.5:1 to about 2:1, the final concentration of the mixture in the paint composition being between about 0.01% to about 60% v/v or weight to weight of a liquid paint base. In further embodiments, the final concentration of the grapefruit seed extract and menthol mixture comprises between about 0.01% to about 25% v/v or weight to weight of a liquid paint base. In other compositions of the invention, the mixture added to the paint base is between about 0.01% to about 25% v/v or weight to weight of a liquid paint base

Another embodiment of the invention comprises a paint base with FRESCALIN™ at between about 0.01% and about 60% (liquid or powder) of a liquid paint base, and about 4% capsicum at a concentration of between about 0.01% to about 60% v/v or weight to weight of a liquid paint base. In one embodiment of the invention wherein the compositions comprise FRESCALIN™ at between about 0.01% and about 15% v/v or weight to weight, the 4% capsicum concentrate (liquid or powder) may be between about 0.01% to about 15% v/v or weight to weight of a liquid paint base. In another embodiment, a concentrate (liquid or powder) comprising about 14% capsicum may be used at a concentration of between about 0.01% to about 60% v/v or weight to weight of a liquid paint base, preferably between about 0.01% to about 15% v/v or weight to weight of a liquid paint base. In yet another embodiment, a concentrate (liquid or powder) comprising about 87% capsicum may be used at a concentration of between about 0.01%to about 60% v/v or weight to weight of a liquid paint base, preferably between about 0.01% to about 15% v/v or weight to weight of a liquid paint base.

In the various embodiments of the paints and coatings of the present invention, phytochemicals may be added in any combination to any type of leaching paints (coatings) (hard and soft), ablative paints (coatings), self-polishing coatings (polymers), the ablative and self-polishing paints further comprising a primer, a resin, a pigment, a solvent, a paint binder and an anti-settling agent

It should be understood that the present invention is not limited to the specific compositions or methods described herein and that any composition having a formula or method steps equivalent to those described falls within the scope of the present invention. Preparation routes of the composition and method steps for treating marine surfaces are merely exemplary so as to enable one of ordinary skill in the art to make the composition and use it according to the described process and its equivalents. It will also be understood that although the form of the invention shown and described herein constitutes preferred embodiments of the invention, it is not intended to illustrate all possible forms of the invention. The words used are words of description rather than of limitation. Various changes and variations may be made to the present invention without departing from the spirit and scope of the invention.

### EXAMPLE

### Anti-Fouling of Marine Immersed Painted Surfaces

A marine paint composition having the formula of 0.7% by volume of a 14% capsicum preparation and 0.4% by weight of menthol was used to coat the surface of a metal plate. Control plates were similarly coated with a paint not containing the agents, or with a commercially available marine anti-fouling paint. The plates were immersed in open ocean water and periodically examined for the extent of marine colonization.

At the end of six moths of immersion, the control metal plates were heavily encrusted with both animal and plant growth including brown and green algae, acorn barnacles and marine worms. In contrast, however, the plates treated with the paint comprising the 0.7% by volume of a 14% capsicum preparation and 0.4% by weight of menthol had very little marine growth over more than 90% of the exposed surface, and where there was growth it was significantly less than would be expected for the period of exposure used.

1. A paint composition for application to a surface for inhibiting the colonization of a painted surface by organisms, the paint composition comprising:
a paint base;
at least one phytochemical dispersed within the paint base, the phytochemical being present in the paint base in an amount sufficient to inhibit the colonization of the painted surface by organisms that come into contact with a surface coated with the paint composition.

2. The paint composition according to claim 1, wherein the paint base is selected from a marine paint base and an architectural paint base.

3. The paint composition according to claim 1, wherein the paint base is selected from the group consisting of an epoxy based paint, a silicone based paint, a polyurea resin, an alkyl, a polyvinyl acetate emulsion, a polyvinyl chloride emulsion, a water based epoxy resin, an acrylic emulsion, an acrylic resin, a copolymer, a synthetic composite, a vinyl, an ablative paint, a self-polishing paint, a leaching paint, a non-leaching paint, an oil-based paint, an aqueous-based paint and derivatives thereof.

4. The paint composition according to claim 1, wherein the phytochemical is selected from the group consisting of a capsicum. preparation, menthol, a menthol derivative, grapefruit seed extract, lemon grass oil, rosemary, sage, bayleaf, oregano, myrtle oil, tea tree oil, citric acid, thyme, Zostera noltil (eel grass extract or derivatives thereof), tannin, neem oil or derivatives or mixtures thereof.

5. The paint composition according to claim 1, further comprising a capsicum preparation.

6. The paint composition according to claim 5, wherein the capsicum preparation has between about 4% capsicum and about 90% capsicum and has a concentration in the paint composition of between about 0.01% to about 60% v/v or weight to weight of a liquid paint base or between about 0.01% to about 15% v/v or weight to weight of a liquid paint base.

7. The paint composition according to claim 5, wherein the capsicum preparation has about 4% capsicum and has a concentration in the paint composition of between about 0.01% to about 60% v/v or weight to weight of a liquid paint base.

8. The paint composition according to claim 5, wherein the capsicum preparation has about 14% capsicum and has a concentration in the paint composition of between about 0.01% to about 60% v/v or weight to weight of a liquid paint base.

9. The paint composition according to claim 5, wherein the capsicum preparation has about 90% capsicum and has a concentration in the paint composition of between about 0.01% to about 60% v/v or weight to weight of a liquid paint base.

10. The paint composition according to claim 5, wherein the capsicum preparation is substantially free of capsaicin.

11. The paint composition according to claim 1, wherein the at least one phytochemical is a mixture comprising grapefruit seed extract and menthol (liquid, crystals or powder) in a weight-to-weight ratio range of from about 1:1 to about 2:1, the final concentration of the phytochemical mixture in the paint composition being between about 0.01% to about 60% v/v or weight to weight of a liquid paint base.

12. The paint composition according to claim 11, wherein the final concentrations of the grapefruit seed extract and menthol are each between about 0.01% to about 25% v/v or weight to weight of a liquid paint base.

13. The paint composition according to claim 4, wherein the menthol derivative is mentholpropylreneglycolcarbonate.

14. The paint composition according to claim 4, wherein the menthol and the menthol derivative each has a concentration in the paint composition of between about 0.01% and about 60% v/v or weight to weight of a liquid paint base.

15. The paint composition according to claim 4, wherein the menthol and the menthol derivative each has a concentration in the paint composition of between about 0.01% and about 15% v/v or weight to weight of a liquid paint base.

16. A paint composition for application to a surface for inhibiting the colonization of a painted surface by organisms, the paint composition comprising:
a paint base selected from the group consisting of an epoxy based paint, a silicone based paint, a polyurea resin, an alkyl, a polyvinyl acetate emulsion, a polyvinyl chloride emulsion, a water based epoxy resin, an acrylic emulsion, an acrylic resin, a copolymer, a synthetic composite, a vinyl, an ablative paint, a self-polishing paint, a leaching paint, a non-leaching paint, an oil-based paint, an aqueous-based paint;
at least one phytochemical dispersed within the paint base, the phytochemical being present in the paint base in an amount sufficient to inhibit the colonization of the painted surface by organisms that come into contact with a surface coated with the paint composition, wherein the phytochemical is selected from the group consisting of a capsicum preparation, grapefruit seed extract, lemon grass oil, myrtle oil, tea tree oil, neem oil, citric acid, thyme, eel grass extract, tannin, rosemary, sage, bayleaf, oregano, or mixtures thereof; and
a menthol or a menthol derivative.

17. A paint composition for application to a surface for inhibiting the colonization of a painted surface by organisms, the paint composition comprising:
a paint base selected from the group consisting of an epoxy based paint, a silicone based paint, a polyurea resin, an alkyl, a polyvinyl acetate emulsion, a polyvinyl chloride emulsion, a water based epoxy resin, an acrylic emulsion, an acrylic resin, a copolymer, a synthetic composite, a vinyl, an ablative paint, a self-polishing paint, a leaching paint, a non-leaching paint, an oil-based paint, an aqueous-based paint;
at least one phytochemical dispersed within the paint base, the phytochemical being present in the paint base in an amount sufficient to inhibit the colonization of the painted surface by organisms that come into contact with a surface coated with the paint composition, wherein the phytochemical is selected from the group consisting of grapefruit seed extract, lemon grass oil, myrtle oil, tea tree oil, citric acid, thyme, eel grass extract, tannin, rosemary, sage, bayleaf, oregano, Zostera noltil (eel grass extract or derivative thereof), or mixtures thereof;
a capsicum preparation; and
a menthol or a menthol derivative.

18. A method for treating a surface to discourage the colonization of the surface by organisms, comprising the steps of:
mixing from about 0.01% to about 60% by weight of a selected paint base selected from the group consisting of an epoxy based paint, a silicone based paint, a polyurea resin, an alkyl, a polyvinyl acetate emulsion, a polyvinyl chloride emulsion, a water based epoxy resin, an acrylic emulsion, an acrylic resin, a copolymer, a synthetic composite, a vinyl, an ablative paint, a self-polishing paint, a leaching paint, a non-leaching paint, an oil-based paint and an aqueous-based paint with at least one phytochemical selected from the group consisting of menthol or a menthol derivative, grapefruit seed extract, lemon grass oil, myrtle oil, tea tree oil, citric acid, thyme, eel grass extract, tannin, neem oil, rosemary, sage, bayleaf, oregano, or derivatives or mixtures thereof; and
applying the mixture to a surface to be protected from colonization, whereby the painted surface is resistant to colonization by a plant or animal.

19. The method according to claim 18, wherein the mixture further comprises a capsicum constituent.

20. The method according to claim 18, wherein the surface to be protected from colonization is selected from a surface subsequently exposed to a marine or freshwater environment or is the surface of an architectural object.
